(19) United States
(12) Patent Application Publication
(10) Pub. No.: US 2007/0051307 A1
(43) Pub. Date: Mar. 8, 2007

(54) Ultrasound apparatus and methods for mixing liquids and coating stents

(76) Inventor: Eilaz P. Babaev, Minnetonka, MN (US)

Correspondence Address: CYR & ASSOCIATES, P.A., PONDVIEW PLAZA, 5850 OPUS PARKWAY SUITE 114, MINNETONKA, MN, 55343, US

(21) Appl. No.: 11/204,872

(22) Filed: Aug. 16, 2005

(51) Int. Cl. B05B 5/025

(52) U.S. Cl. 118/620

(57) ABSTRACT

Ultrasound methods and apparatus for mixing two or more different liquids are disclosed. The ultrasound methods and apparatus may mix varied components including drugs, polymers, and coatings for application to a variety of medical apparatus surfaces. The apparatus and technique can generate a proper mixture which is uninterruptedly/continuously delivered to the surface of the medical apparatus. The apparatus may include specific ultrasound transducer/tip configurations which may allow for the mixing of different liquids in a mixing camera located inside of the vibrating tip. The apparatus and methods of the present invention may mix different drugs, applying them to stent surface using different effects like ultrasound cavitation and radiation forces. Furthermore, the disclosed methods and apparatus may generate a mixture and may deliver a targeted, gentle, highly controllable dispensation of continuous liquid spray which can reduce the loss of expensive pharmaceuticals.

### BACKGROUND OF THE INVENTION

1. Field of the Invention

The present invention relates to the coatings for medical devices and, more particularly, to apparatus and methods using ultrasound energy for mixing two or more different liquids and coating any medical device surfaces.

2. Background of the Related Art

A stent is a generally small, cylindrical shaped, mesh tube that is inserted permanently into an artery. A stent helps hold open an artery so that blood can flow through it. Stents can generally be divided into two categories: a) Metallic Bare Stents; and b) Drug Eluting Stents. Drug-eluting stent contain drugs that potentially reduce the chance the arteries will become blocked again.

The stents are generally tubular in design made up of fine mesh and/or wire having a small diameter and defining a large number of narrow spaces between various components. Frequently, stents are coated with a range of materials utilizing various methodologies and for various reasons. Because of their specific construction, designs and materials, uniformly coating the inner and outer surfaces of the stent, repeatably with no webbing, stringing and with controllable dosage of drug-polymer coating has been problematic.

Examples of patents disclosing stents include U.S. Pat. No. 4,739,762 by Palmaz; U.S. Pat. No. 5,133,732 by Wiktor; U.S. Pat. No. 5,292,331 by Boneau; U.S. Pat. No. 6,908,622 by Barry et al.; U.S. Pat. No. 6,908,624 Hossayniy et al.; and U.S. Pat. No. 6,913,617 by Reiss.

There are a variety of U.S. Published Patent Applications related to stent coatings, including, for example: U.S. Pat. Pub. No. 2003/0225451 A1 by Sundar; U.S. Pat. Pub. No. 2004/0215336 A1 by Udipi, et al.; U.S. Pat. Pub. No. 2004/0224001 A1 by Pacetti, et al.; U.S. Pat. Pub. No. 2004/0234748 A1 by Stenzel; U.S. Pat. Pub. No. 2004/0236399 A1 by Sundar; and U.S. Pat. Pub. No. 2004/0254638 A1 Byun.

According to above-mentioned patents and applications, the coating have been applied to the surface of stents from both inside and outside by different methods, such as mechanical coating, gas spray coating, dipping, polarized coating, electrical charge (electrostatic) coating, ultrasound coating, etc. Some of them like U.S. Pat. No. 6,656,506 utilize a combination of dipping and spraying). Several of them utilize the ultrasound energy, such as, for example, U.S. Pat. No. 6,767,637; and U.S. Pat. Pub. No. 2005/0064088 for ultrasound spraying. In another method, U.S. Pat. No. 5,891,507 discloses coating the surface of a stent by dipping in ultrasonic bath.

Despite these coating technologies and methods, these related technologies have numerous shortcomings and problems. For example, non-uniformity of coating thickness, webbing, stringing, bare spots on the stent surface, drug wasting, over spray, difficulties with control of drug flow volume, adhesive problems, long drying time and a need sterilization/sanitation, among others.

Ultrasonic sprayers (Sonic and Materials Inc., Misonix Inc., Sono-Tek Inc.; U.S. Pat. Nos. 4,153,201, 4,655,393, and 5,516,043) typically operate by passing liquid through the central orifice of the tip of an ultrasound instrument. Known applications from US Engineering, are use of a gas stream to deliver aerosol particles to coating surface. According to Sono-Tek's web site, the AccuMist and MicroMist systems are being use for ultrasonic stent coating by delivering aerosol particles via air jet or gas stream.

Among prior gas ultrasound sprayers are Celleration wound treatment applications (U.S. Pat. Nos. # 5,076,266; 6,478,754; 6,569,099; 6,601,581; 6,663,554), which are creating the spray. USSR patent # 1237261, issued for Babaev in 1986 can mix the different liquid outside of ultrasound transducer tip

Typically, stents need to be coated with a drug and/or polymer in single layer. Current techniques require the drug or polymer be mixed before coating. This can lead to timing issues such as when a polymer is polymerizing after mixing.

Accordingly, there is a need for a method and device for mixing two or more different drugs with the polymers and defect-free, controllable coating process of the stents.

### SUMMARY OF THE INVENTION

According to the present invention, ultrasonic method and apparatus for stent coating is described. The present ultrasonic method and apparatus may provide a proper mixing of two or more different liquids in a mixing chamber (camera) defined by an ultrasound transducer tip. Apparatus in accordance with the present invention may create the uniform, gentle and targeted spray for coating of the surface.

In one aspect, the present invention is directed to interruptedly mix different liquids and coat stents with controllable thickness of layer without webbing and stringing.

In another aspect, the present invention may provide apparatus including a mixing chamber (camera) located inside of the ultrasound transducer tip. A controlled amount of different liquids from different reservoirs may be provided the mixing chamber (camera) of the ultrasonic tip. The ultrasonic tip may be cylindrical, rectangular or otherwise shaped to create proper mixture. The mixture created may delivered to distal end of the tip via central orifice to create a fine spray.

Liquid may be controllably delivered into the mixing chamber using precise syringe pumps by capillary or and gravitational action. When using syringe pumps, the amount of liquid delivered may be approximately the same volume or weight of coating layer.

A method of present invention for coating medical devices including stents can create a desired mixture inside of ultrasonic tip from different liquids, drug, polymers, among other materials and can provide uninterruptedly sprays to the surface.

Methods in accordance with the present invention may also use a number of acoustic effects of low frequency ultrasonic waves, such as cavitation, micro streaming, and standing waves inside of the mixing chamber in ultrasonic tip, which are not typically utilized in liquid mixing or coating technologies.

The method may include spinning of stent and moving of ultrasound mixing and coating head during the coating process to create special ultrasonic—acoustic effects, which will be describe in details below. All coating operation runs with special software program to achieve high quality results.

The method and apparatus can mix different liquids such as drugs, polymers, etc., and coat rigid, flexible, self expanded stents made by different materials.

A method also may include directing the further gas flow onto mixing and coating area. Gas flow may be hot or cold and directed through mixing chamber and/or spray within particles or separate.

Device part of invention consists specific construction of ultrasonic tips, which allows mix of different liquids and uninterruptedly create the spray.

The rate of ultrasound frequency may be between 20 KHz and 20 MHz or more. Preferable frequency is 20 KHz to 200 KHz, recommended frequency is 30 KHz. The rate of ultrasound waves amplitude may be between 2 micron and 300 micron or more. Thereby, there is provided a method and device for uninterruptedly ultrasound stent coating with proper mixing of different liquids with no webbing and stringing

One aspect of this invention may be to provide a method and device for mixing two ore more different liquids.

Another aspect of the invention may be to provide a method and device for mixing two or more unmixable liquids.

Another aspect of the invention may be to provide an improved method and device for mixing two or more different drugs, polymers, or drug with the polymer for coating of medical implants such as a stents.

Another aspect of this invention may be to provide a method and device for mixing two or more different liquids, such a drugs, polymers, or drug with the polymer and coating of stents using ultrasound

Another aspect of this invention may be to provide method and device for mixing two or more different drugs with the polymers, that provides controllable thickness of coating layer

Another aspect of the invention may be to provide method and device for simultaneous mixing of different liquids, creation of continuous, uniformed, directed spray from proper mixture coating of stents

Another aspect of the invention may be to provide method and device for simultaneous mixing of different liquids, creation of continuous, uniformed, directed spray from proper mixture coating of stents, that avoids the coating defects like webbing, stringing, etc.

Another aspect of the invention may be to provide method and device for simultaneous mixing of different liquids, creation of continuous, uniformed, directed spray from proper mixture coating of stents, which increases the adhesivity property of stents with no chemicals.

Another aspect of the invention may be to provide method and device for simultaneous mixing of different liquids, creation of continuous, uniformed, directed spray from proper mixture coating of stents, that provides drying of coating layer along the longitudinal axis of the structure simultaneously with the coating process

Another aspect of the invention may be to provide method and device for simultaneous mixing of different liquids, creation of continuous, uniformed, directed spray from proper mixture coating of stents, that provides sterilization of coating layer along the longitudinal axis of the structure simultaneously with the coating process

Another aspect of invention may be to provide method and device for creation of uninterrupted process of proper mixing two or more different liquids, creating the spray and coating the surface

These and other aspects of the invention will become more apparent from the written description and figures below.

### BRIEF DESCRIPTION OF THE DRAWINGS

The present Invention will be shown and described with reference to the drawings of preferred embodiments and clearly understood in details.

FIG. 1 is a cross sectional view of an embodiment of an ultrasonic mixing apparatus in use with the spray according to present invention.

FIG. 2 illustrates the frontal view in cross section an embodiment of an apparatus with the delivery of liquid directly to mixing camera inside of ultrasonic tip according to present invention. Liquid delivery tubes are located on one platan, perpendicular to axis of tip.

FIG. 3 illustrates the cross section of an embodiment of an apparatus with the delivery of liquid directly to mixing camera inside of ultrasonic tip according to present invention. Liquid delivery tubes are located on the platan, along ultrasonic tip's longitudinal axis.

FIG. 4 is a illustration of cross section of an embodiment of an apparatus with the threaded mixing camera inside of ultrasonic tip according to present invention.

FIG. 5 illustrates the front view of cross section of an embodiment of an apparatus with the delivery of one liquid to mixing camera through central orifice of ultrasound transducer, and another liquid through the tube, perpendicular to ultrasonic tip's axis according to present invention

FIGS. 6A and 6B illustrate embodiments of mixing chambers in expanded cross section having rounded radiation walls

FIG. 7 illustrates embodiments of ultrasonic tips which are a) expanded flat, b) conical shape, c) exponential d) outside rounded, e) inside rounded-focused, and f) rectangular distal end configurations.

### DETAILED DESCRIPTION OF THE INVENTION

The present invention provides an apparatus including an ultrasonic tip 1 defining a mixing chamber (camera) 4. Preferred embodiments of the present invention in the context of a method and apparatus are illustrated throughout the figures. Those skilled in the art will immediately understand the advantages for mixing of two or more different liquids such as a drugs and/or polymers and uninterruptedly coating the stent that will be provided by the present inventions upon review of the present disclosure.

The ultrasonic tip 1 uses ultrasonic energy provided by an ultrasound transducer 2 to mix materials and coat medical apparatus. The methods are particularly useful when applied to coating stents and other devices having intricate details and complex shapes. Ultrasonic tips 1 in accordance with the present invention can provide highly controllable precise mixing of two or more drugs and polymers and fine, targeted spray allows the coating of stents without substantial webbing, stringing and wasting the expensive drug by mixing.

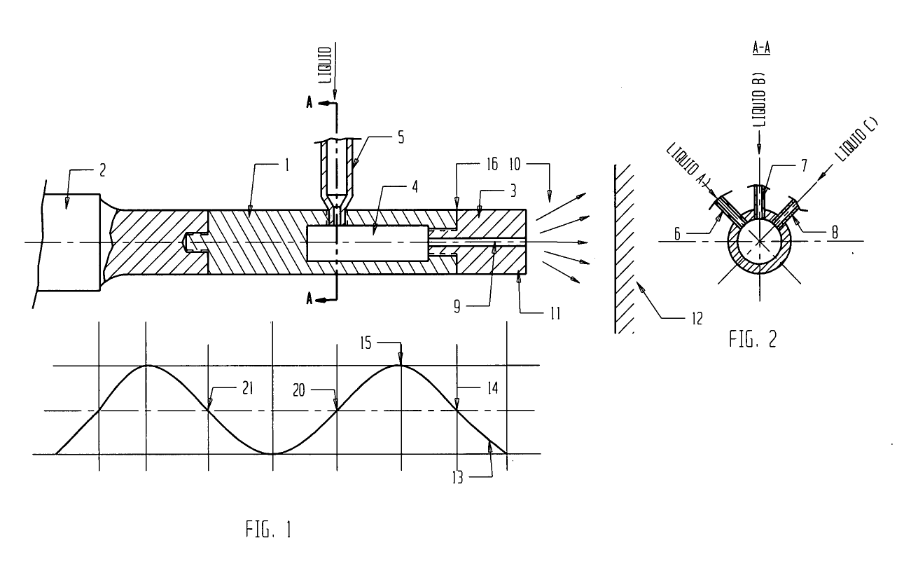

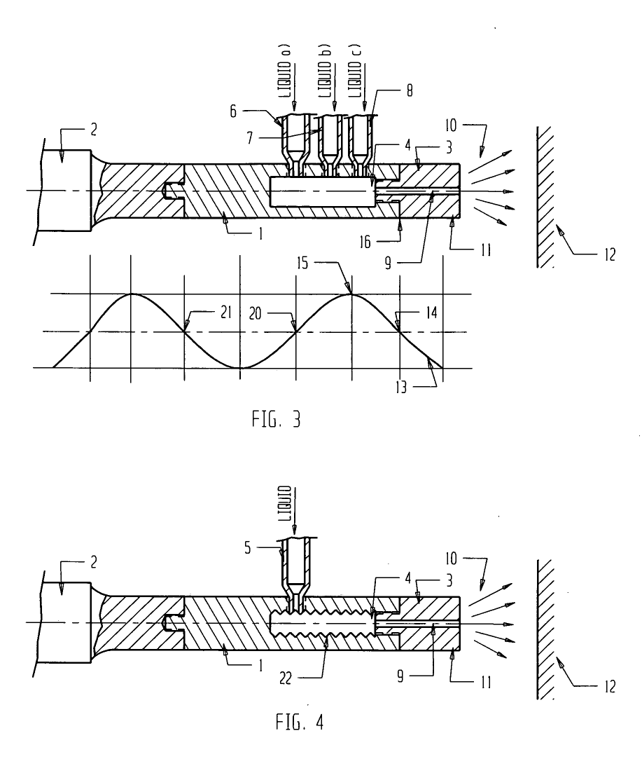

The present invention provides a novel ultrasonic tip 1 and method for mixing two or more different fluid to coat a stent. Embodiments of ultrasonic tip 1 in accordance with the present invention are illustrated in FIGS. 1 to 7. According to present invention, ultrasonic tip 1 includes a mixing chamber/camera 4 inside of ultrasonic tip 1. The mixing chamber 4 provides ultrasonically active space for mixing of different liquids under acoustic forces including cavitation phenomena which can occur inside of chamber 4. Typically, chamber 4 is of a cylindrical shape about the longitudinal axis of the ultrasonic tip 1. The cavitation phenomena may occur between walls 18 and 19 of the chamber perpendicular to longitudinal axis. One or more syringe pumps (not shown) may be provided for delivery of different liquids into chamber 4 through tubes 5, 6, 7, 8, (FIG. 2), located on the platan perpendicular to longitudinal axis. Liquid delivery tubes 6, 7, 8 may be located along longitudinal axis (FIG. 3) is one of the embodiment of present invention. In one aspect, one or more of the delivery tubes 6, 7, 8 may provide a pressurized fluid. Mixtures of drugs and/or polymers may be delivered in an uninterruptedly fashion to a radiation surface 11 of tip 1 through an orifice 9 for creation of spray 10 and delivery to coating surface/stent 12. Diameter of orifice 9 preferably must be less than diameter of mixing chamber. To simplify manufacture, an ultrasound transducer 2 an ultrasonic transducer tip 1 may include a distal end part 3 which is attached via threads on planar 16 to form the chamber 4. Distal end part 3 may be provided with different diameter of central orifice 9 to create spray 10 in needed particle size. To avoid the loose of distal end part 3 has to be attached to tip 1 preferably on amplitudes node point 14. Liquid delivery tubes (5, 6, 7, 8) also have to be attached to tip 1 preferably on amplitudes node point 20. To achieve a high quality mixture, mixing cameras center can match or be near to the amplitudes anti node point 15.

It is important to note that gas stream with different temperature can be delivered into mixing chamber/camera 4 through one of the tubes (5, 6, 7, 8) to improve liquid mixing and spray coating process. This can change spray volume, quality and may expedite the drying process.

Clarification and description of ultrasound different liquid mixing and uninterruptedly spraying process, method and apparatus: When different liquids (a, b, c) are provided into activated mixing chamber 4, wall 19 under ultrasound radiation force delivers liquid drops/flow forward. Retrograded or ricocheted from wall 18 pressurized liquid flow encounter with fresh delivered different liquid flow and creates proper mixture under ultrasound radiation/pressure forces and cavitation.

After mixing chamber fills with liquid mixture, ultrasound pressure forces the mixture through central orifice 9 to create spray 10 and delivers it to radiation surface 11. As the liquids are delivered and the tip vibrates, the mixing and spray coating process are occurring uninterruptedly.

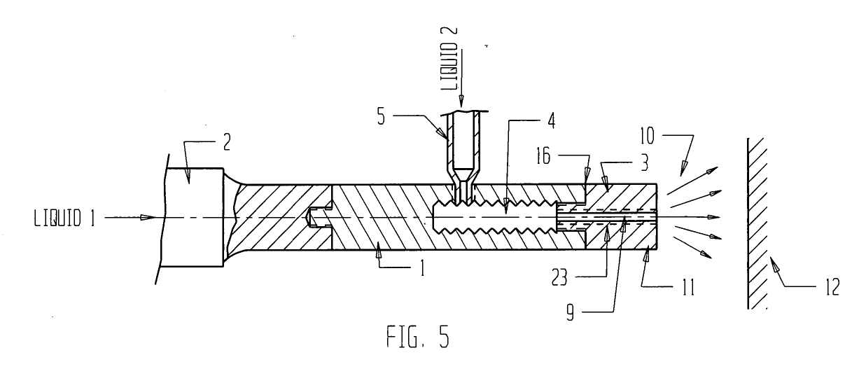

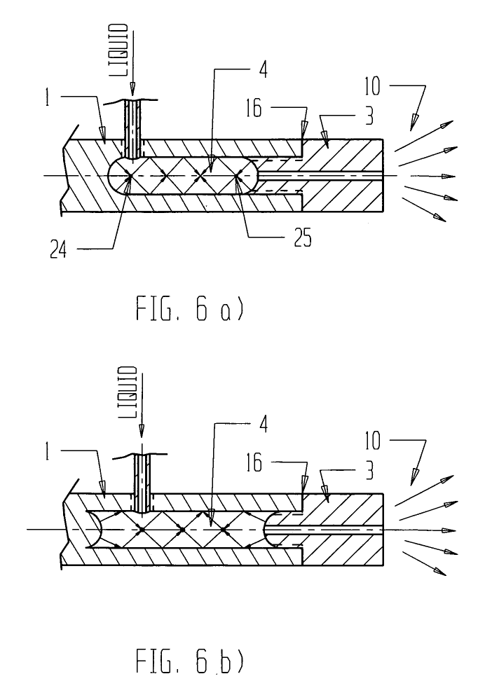

In one aspect of present invention, for more effective and proper mixing process, mixing chamber 4 consists at list one thread 22, groove ring or a waved shape (FIG. 5). In this case toot of tread acts as a mixing blade or spoon, forcing different liquids with ultrasonic energy to be mixed. Distal end orifice 9 also can be threaded (23) for better mixing process.

In another aspect (FIG. 6), for more effective and proper mixing process, mixing chambers wall 18 and 19 can be rounded inside (FIG. 6.a) to create focused ultrasonic effect, which is much powerful. Chamber walls also can be rounded outside (FIG. 6. b) for creation of powerful cavitation effect to achieve more proper mixing process. In this case ultrasound waves being reflected from radial cylindrical walls of mixing camera forces different liquid particles toward each other. These provide proper mixing of different liquids under ultrasound cavitation and radiation pressure.

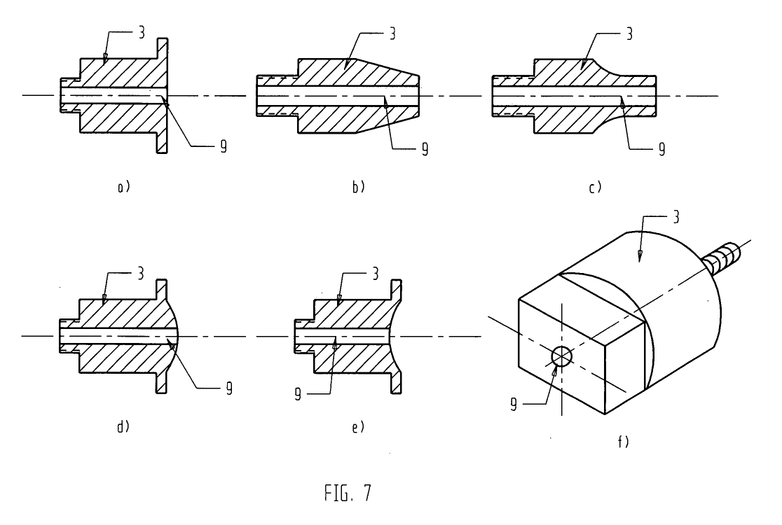

FIG. 7 is illustration of ultrasonic tip's a) expanded flat, b) conical shape, c) exponential d) outside rounded, e) inside rounded-focused and f) rectangular distal end configurations. These configurations allows to control spray angle and quality depended on coating requirements.

What is claimed is:

1. An apparatus for mixing at least two different liquids and coating at least portion of at least one stent comprising: a) an ultrasound transducer having a tip;
b) an ultrasound transducer tip having mixing chamber inside of the vibrating tip;
c) an ultrasound transducer tip's mixing chamber having tubes to deliver liquid into chamber; and
d) an ultrasound transducer tip's mixing chamber having central orifice to provide mixture of liquid to the distal end of tip to be sprayed;

2. An apparatus of claim 1, wherein ultrasonic tip's mixing chamber has a thread or groove

3. An apparatus of claim 1, wherein ultrasonic tip's mixing chamber has front end part, attached to tip on node point via thread;

4. An apparatus of claim 1, wherein ultrasonic tip's mixing chamber has liquid delivery tubes, attached to tip on node point.

5. An apparatus of claim 1, wherein ultrasonic tip's front end part has a different geometrical form/shape;

6. An apparatus of claim 1, wherein ultrasonic tip's mixing chamber has a thread or groove

7. An apparatus of claim 1, wherein liquid mixing chamber's at least one of rear and/or front walls are flat;

8. An apparatus of claim 1, wherein liquid mixing chamber's at least one of rear and/or front walls are round or oval;

9. An apparatus of claim 1, wherein liquid mixing chamber's diameter is greater than front end part's central orifice diameter;

10. A method for mixing at least two different liquids, comprising:
a) having ultrasound transducer tip with mixing chamber, provided inside of vibrating tip
b) delivering at least two different liquids into mixing camera
c) delivering at list two different liquids and at least one gas stream via one of the liquid delivery tube
c) creating mixture at least from two different liquids using ultrasound cavitation and radiation forces
d) delivering the mixture to distal end of tip via central orifice to create the spray
e) directing and applying a mixture coating spray onto the stent

11. The method of claim 10, comprising use of different ultrasound wave frequencies for mixing of different liquids inside of vibrating tip.

12. The method of claim 10, further comprising use of different ultrasound wave amplitudes for mixing of different liquids inside of vibrating tip.

13. The method of claim 10, wherein at least one of the liquids is a therapeutic agent/drug.

14. The method of claim 10, wherein at least one of the liquids is a polymer

15. The method of claim 10, wherein one of the liquids is a mixture
